(19) United States
(12) Patent Application Publication
(10) Pub. No.: US 2015/0343563 A1
(43) Pub. Date: Dec. 3, 2015

(54) WELDING METHOD HAVING WELDING POWER DEPENDING UPON THICKNESS

(71) Applicant: SIEMENS AKTIENGESELLSCHAFT, München (DE)

(72) Inventor: Bernd BURBAUM, Falkensee (DE)

(21) Appl. No.: 14/759,672

(22) PCT Filed: Nov. 13, 2013
(86) PCT No.: PCT/EP2013/073711

§ 371 Date: Jul. 8, 2015

(30) Foreign Application Priority Data
Feb. 1, 2013 (EP) 13153575.9

(51) Int. Cl. B23K 26/20; B23K 26/32

(52) U.S. Cl. CPC B23K 26/20; B23K 26/3213

(57) ABSTRACT

The invention relates to an a priori calculation of the laser power on the basis of heat conduction, wherein the power is specified depending upon thickness along the welding trace, such that a constant thickness of a welding trace is achieved.

### CROSS-REFERENCE TO RELATED APPLICATIONS

The present application is a 35 U.S.C. §§371 national phase conversion of PCT/EP2013/073711, filed Nov. 13, 2013, which claims priority of European Application No. 13153575.9, filed Feb. 1, 2013, the contents of which are incorporated by reference herein. The PCT International Application was published in the German language.

### TECHNICAL FIELD

The invention relates to a welding method, in which the welding power is adapted to the thickness of a substrate.

### TECHNICAL BACKGROUND

In the case of components which are subjected to loading and are produced from nickel-based superalloys solidified in polycrystalline form, marginal-layer remelting of cracks close to the surface by means of laser radiation is desired in order to close the cracks and in order to retain the mechanical properties of the components to be repaired in the region of the base material. The remelting of regions of a turbine blade or vane having relatively large variations in the material thicknesses (3 mm-1 mm) can lead to different molten bath depths when remelting with a constant laser power at the molten bath surface.

### SUMMARY OF THE INVENTION

It is therefore an object of the invention to solve the aforementioned problem.

Investigations carried out to date on sample geometries of nickel-based superalloys show that the deviations in the remelting depth are reduced by 50% compared to remelting with a constant laser power as a result of remelting with a constant process temperature at the molten bath surface.

However, an advantageous remelting depth along the remelted path is achieved only by a path-dependent welding power calculated in advance (a priori).

### BRIEF DESCRIPTION OF THE DRAWINGS

FIGS. 1, 2 and 3 show procedures or results, according to the invention, of the method,

FIG. 4 shows a list of superalloys.

### DESCRIPTION OF EMBODIMENTS

The figures and the description represent only exemplary embodiments of the invention.

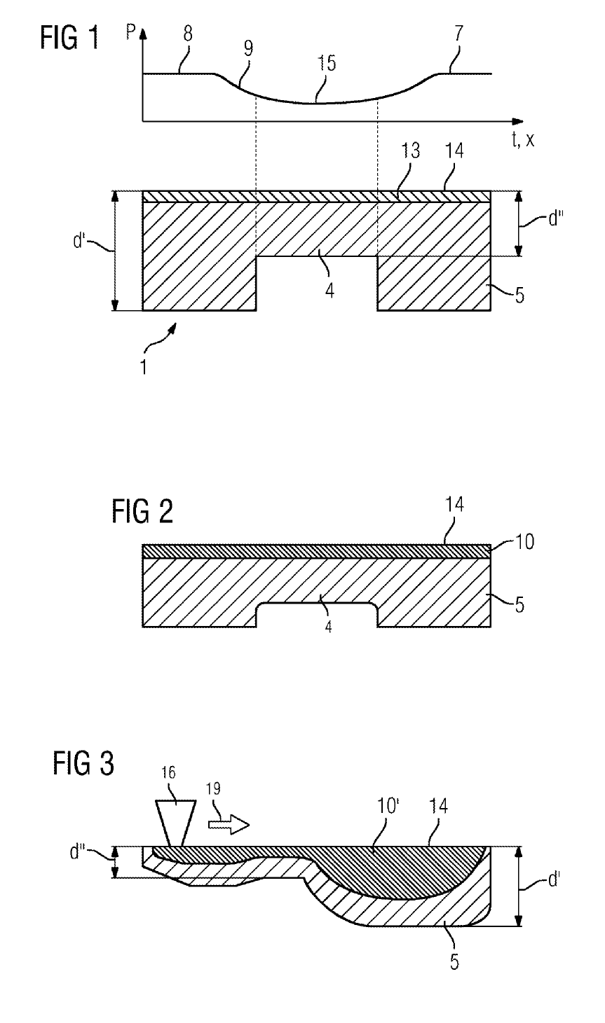

FIG. 1 schematically shows a component 1 comprising of a substrate 5 which has been subjected to a welding method on the surface 14. The welding power P is shown as a function of the thickness d′, d″ along the section x or the time t.

In a region 4, the substrate 5 has a thinner wall thickness d″ (<d′), because a duct is present internally there, for example.

This is the case, for example, in turbine blades or vanes which have internal meandering cooling ducts delimited by walls. A cooling duct of this type represents a recess or a thinner wall region 4.

The substrate 5 is preferably to be remelted at the surface 14, or build-up welding is to take place. The method hereof is particularly suitable for remelting.

There is no regulation of the welding power on account of the temperature of the molten bath surface in the region of the focus of the welding beam 16 (FIG. 3). Instead, a simulation of the molten bath depth is carried out a priori on the basis of heat conduction calculations along the welding path 13 and welding direction 19.

The aim of adapting the welding power P is preferably to achieve a constant thickness of the molten or applied region 13.

This is shown in FIG. 1, in which a certain welding power P is present at the start 8 in the thicker region d′. This welding power is already being reduced 9 when the welding beam 16 (FIG. 3) approaches the thinner (d″) region 4 or has not yet reached it.

The welding power P reaches a minimal value 15 only when the region 4 has already been reached by the welding beam 16. The welding power P also increases further after the thinner (d″) region 4 has been crossed, until it reaches a higher value 7 again.

The wall thickness d′, d″ is the thickness in the direction of a welding beam 16 (FIG. 3) or in the direction of build-up of the material during the build-up welding, but not parallel to the surface 14.

The curve profile of the welding power P is shown only schematically.

It is significant that the welding power P is not configured in a manner corresponding to the contour of the region 4, i.e. it is not reduced in a ramp-like manner, but instead is lowered in advance before the thinner (d″) region 4 is reached and also only rises slowly again preferably after the thinner (d″) region 4 has been left, and is not increased again in a ramp-like manner.

This is caused by the heat conduction, which has the effect that regions still to be remelted are also heated in advance already by a flow of heat and the introduction of energy required for melting and heating is reduced. The heat conduction is influenced by the introduction of heat by the welding beam 16 and the cross section (thickness) of the region 13 to be melted and also the thickness of the material transverse to the direction of movement 19 of the welding beam 16.

FIG. 2 shows a test result, in which a region 4 having a thinner wall is present, and a remelting region 10, having a relatively constant remelting depth.

In FIG. 1, it has been assumed that a maximum crack depth is present, on the basis of which the thickness of the remelting region 13 which is to be remelted is stipulated.

It is also possible, however, for the crack depths to be greatly different along a direction of movement 19, and, in the thicker region d′, to exceed the thickness d″ of a thinner region (FIG. 3).

Here, too, it is possible to calculate the welding power in order to remelt the crack in an optimally and locally adapted manner at its different crack depths, in order to achieve remelting regions 10′ of differing thickness or thicker remelting regions 10′.

The method is preferably carried out for nickel-based or cobalt-based superalloys.

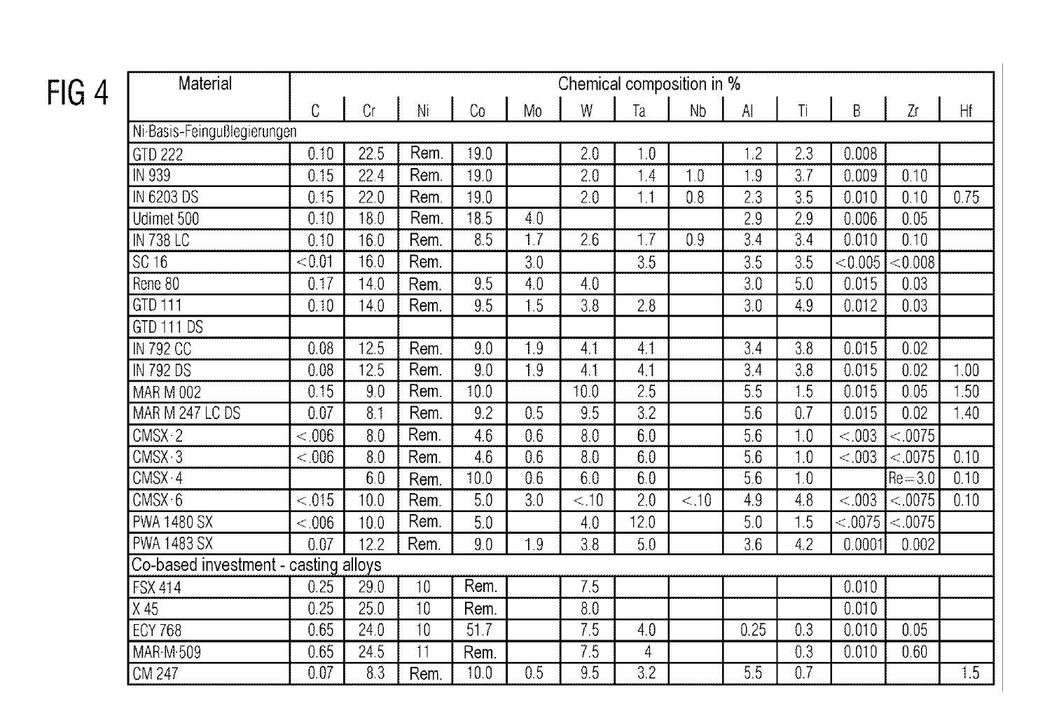

The substrate 5 is preferably a nickel-based or cobalt-based superalloy, also very particularly as shown in FIG. 4.

1-15. (canceled)

16. A welding method, using welding power, comprising:
varying the welding power to relate to a varying wall thickness of a substrate, during welding on the substrate, the varying comprising determining the welding power a priori based on heat conduction calculations in the substrate related to differing thickness along a direction of movement of a welding beam.

17. The method as claimed in claim 16, further comprising lowering the welding power in a region in which a thinner wall region of the substrate is present.

18. The method as claimed in claim 16, further comprising reducing the welding power of a welding beam before the welding beam reaches the thinner wall region.

19. The method as claimed in claim 18, further comprising increasing the welding power in a thicker region and even after the thinner wall region has been crossed.

20. The method as claimed in claim 16, wherein the welding power does not correspond exactly to a profile of the thickness conditions of the substrate.

21. The method as claimed in claim 16, wherein the welding method is a laser welding method.

22. The method as claimed in claim 16, further comprising performing a remelting method of a surface of the substrate before welding on the surface of the substrate at the remelt.

23. The method as claimed in claim 16, further comprising welding a polycrystalline substrate.

24. The method as claimed in claim 22, further comprising achieving a constant molten bath depth of a remelting region on the substrate.

25. The method as claimed in claim 22, further comprising achieving different molten bath depths of a remelting region on the substrate.

26. The method as claimed in claim 16, further comprising performing a build-up welding method.

27. The method as claimed in claim 16, wherein the substrate has a wall thickness which is the thickness of the substrate in a direction of movement of a welding beam used in the welding method and the movement is over a surface of the substrate.

28. The method as claimed in claim 16, wherein the substrate has a wall thickness which is the thickness of the substrate in a direction of build-up of powder material for forming the weld.

29. The method as claimed in claim 16, further comprising changing the welding power changes during the welding method within a transition over a surface of the substrate.
